(19) United States
(12) Patent Application Publication
(10) Pub. No.: US 2026/0037781 A1
(43) Pub. Date: Feb. 5, 2026

(54) METHOD AND SYSTEM OF BEARING FAULT DIAGNOSIS BASED ON DUAL ATTENTION MECHANISM TO STRENGTHEN HIERARCHICAL DECISION NETWORK

(71) Applicant: Zhejiang Normal University, Jinhua City (CN)

(72) Inventors: Zhilin DONG, Jinhua City (CN); Yonghua JIANG, Jinhua City (CN); Weidong JIAO, Jinhua City (CN); Chao TANG, Jinhua City (CN); Wanxiu XU, Jinhua City (CN); Jianfeng SUN, Jinhua City (CN); Siyu LIU, Jinhua City (CN); Daxuan LIN, Jinhua City (CN)

(21) Appl. No.: 19/262,466

(22) Filed: Jul. 8, 2025

(30) Foreign Application Priority Data
Aug. 2, 2024 (CN) 202411056336.X

(51) Int. Cl. G06F 11/07

(52) U.S. Cl. CPC G06F 11/079

(57) ABSTRACT

A method and a system of bearing fault diagnosis based on a dual attention mechanism to strengthen a hierarchical decision network are provided, where the method includes the following steps: collecting bearing vibration signals in different health states; based on the bearing vibration signals, constructing a hierarchical multi-class fault diagnosis model; and determining a fault position and a fault size of a bearing by using the hierarchical multi-class fault diagnosis model.

### CROSS-REFERENCE TO RELATED APPLICATIONS

This application claims priority to Chinese Patent Application No. 202411056336.X, filed on Aug. 2, 2024, the contents of which are hereby incorporated by reference.

### TECHNICAL FIELD

The disclosure relates to the field of bearing fault detection, and in particular to a method and a system of bearing fault diagnosis based on a dual attention mechanism to strengthen a hierarchical decision network.

### BACKGROUND

In the existing bearing fault detection, the fault diagnosis of bearing health state classification is carried out under a relatively balanced data set. However, in real fault diagnosis, on the one hand, different types of bearing fault data are unevenly distributed, which makes the training and testing of the model more complicated. On the other hand, the inevitable noise environment may further interfere with the feature extraction and diagnosis process of bearing signals. Therefore, it is still a very challenging task to realize bearing fault diagnosis well in the environment of unbalanced data and strong noise interference. In terms of related technologies, although convolutional neural network (CNN) assisted by attention mechanism has shown great ability in feature extraction and achieved encouraging results in the task of bearing fault diagnosis, CNN has two main shortcomings: CNN only pay attention to input signals and output results, ignoring the effective reasoning of intermediate processes, which reduces the credibility of diagnosis results; and the bearing fault position and size are classified as the same level, which deviates from the conventional thinking process of human beings.

### SUMMARY

In order to solve the technical problems in the above background, the disclosure proposes a hierarchical multi-class fault diagnosis model of a dual attention guided tree-inspired grade decision network, aiming at realizing the fault diagnosis of bearing health state classification in an unbalanced and strong noise environment.

In order to achieve the above objectives, the disclosure provides a method of bearing fault diagnosis based on a dual attention mechanism to strengthen a hierarchical decision network, including the following steps:
collecting bearing vibration signals in different health states;
based on the bearing vibration signals, constructing a hierarchical multi-class fault diagnosis model; and
determining a fault position and a size of a bearing by using the hierarchical multi-class fault diagnosis model.

Optionally, the hierarchical multi-class fault diagnosis model includes a dual attention-guided mechanism and a tree-inspired grade decision network;
the dual attention-guided mechanism is used to enhance information closely related to fault information in bearing fault signals and weaken interference information not closely related to the fault information; and
the tree-inspired grade decision network is used to decide the position and the size of bearing faults grade by grade.

Optionally, a construction method of the dual attention-guided mechanism includes: integrating a ternary attention mechanism and a multi-head convolutional attention mechanism into a convolutional neural network (CNN) model to form the dual attention-guided mechanism;
where the ternary attention mechanism introduces a convolutional block attention module through a concept of cross-dimensional interaction, enabling an interaction between channels and spatial dimensions more compact and comprehensive; and
a multi-head convolutional self-attention (MCSA) mechanism is used to reduce cost of memory use and calculation in a process of training or inference, while maintaining interactivity and diversity among multi-heads.

Optionally, the tree-inspired grade decision network is designed based on basic logic of fault diagnosis tasks, including: a fault type layer and a fault size layer;
the fault type layer is used for determining a fault type of an input sample; and
the fault size layer is used for determining a fault size of the input sample.

Optionally, the dual attention-guided mechanism is used as a backbone network of the hierarchical multi-class fault diagnosis model; meanwhile, the tree-inspired grade decision network with a two-layer structure is built by using two fully connected layers; weight information generated by the fully connected layers in the backbone network is inherited by thresholds of seed nodes of the tree-inspired grade decision network, and thresholds of leaf nodes are further determined by embedding decision rules of the seed nodes and the leaf nodes.

The disclosure also provides a system of bearing fault diagnosis based on a dual attention mechanism to strengthen a hierarchical decision network, which is used for realizing the above method and includes an acquisition module, a construction module and a detection module;
where the acquisition module is used for acquiring the bearing vibration signals in the different health states;
the construction module is used for building the hierarchical multi-class fault diagnosis model based on the bearing vibration signals; and
the detection module is used for determining the fault position and the size of the bearing by using the hierarchical multi-class fault diagnosis model.

Optionally, the hierarchical multi-class fault diagnosis model includes a dual attention-guided mechanism and a tree-inspired grade decision network;
the dual attention-guided mechanism is used to enhance information closely related to fault information in bearing fault signals and weaken interference information not closely related to the fault information; and
the tree-inspired grade decision network is used to decide the position and the size of bearing faults grade by grade.

Optionally, a workflow of the construction module includes: integrating a ternary attention mechanism and a multi-head convolutional attention mechanism into a CNN model to form the dual attention-guided mechanism;
where the ternary attention mechanism introduces a convolutional block attention module through a concept of cross-dimensional interaction, enabling an interaction between channels and spatial dimensions more compact and comprehensive; and
the MCSA mechanism is used to reduce the cost of the memory use and the calculation in the process of the training or the inference, while maintaining the interactivity and the diversity among the multi-heads.

Compared with the prior art, the disclosure has the following beneficial effects.

The disclosure accurates identification of the bearing health state be realized in an unbalanced and strong noise environment, and the decision-making process of the sample state type is interpretable. Moreover, the decision-making idea of “locating the fault position first and then quantifying the fault size” is different from the previous practice of “mixed decision-making of fault position and size at the same level”, which is more in line with the conventional cognition of human beings.

### BRIEF DESCRIPTION OF THE DRAWINGS

In order to explain the technical scheme of the present disclosure more clearly, the drawings needed in the embodiments are briefly introduced below. Obviously, the drawings in the following description are only some embodiments of the present disclosure. For ordinary people in the field, other drawings may be obtained according to these drawings without paying creative labor.

FIG. 1 is a schematic flow diagram of a method according to an embodiment of the present disclosure.

FIG. 2 is a schematic diagram of an input part of a model structure of an embodiment of the present disclosure.

FIG. 3 is a schematic diagram of a dual attention-guided mechanism of the model structure of the embodiment of the present disclosure.

FIG. 4 is a schematic diagram of a tree-inspired grade decision layer of the model structure according to an embodiment of the present disclosure.

### DETAILED DESCRIPTION OF THE EMBODIMENTS

In the following, the technical scheme in the embodiments of the disclosure will be clearly and completely described with reference to the attached drawings. Obviously, the described embodiments are only a part of the embodiments of the disclosure, but not the whole embodiments. Based on the embodiments in the present disclosure, all other embodiments obtained by ordinary technicians in the field without creative labor belong to the scope of protection of the present disclosure.

In order to make the above objectives, features and advantages of the present disclosure more obvious and easier to understand, the present disclosure will be further described in detail with the attached drawings and specific embodiments.

### Embodiment 1

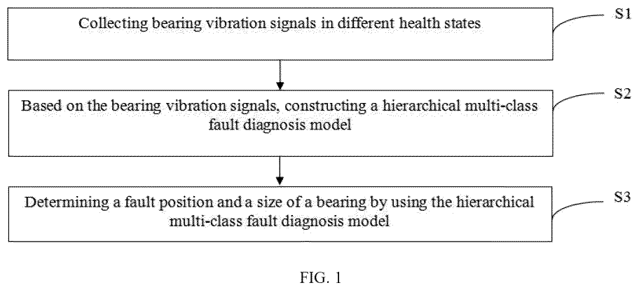

FIG. 1 is a schematic flow chart of the method of the present disclosure, and the steps include:

S1, collecting bearing vibration signals in different health states.

In this embodiment, the collected vibration signal samples are the vibration signals of unbalanced bearing samples whose bearings have various health states under the noise background, which are collected from the fault test bench by using special acceleration sensors.

S2, based on the bearing vibration signals, constructing a hierarchical multi-class fault diagnosis model.

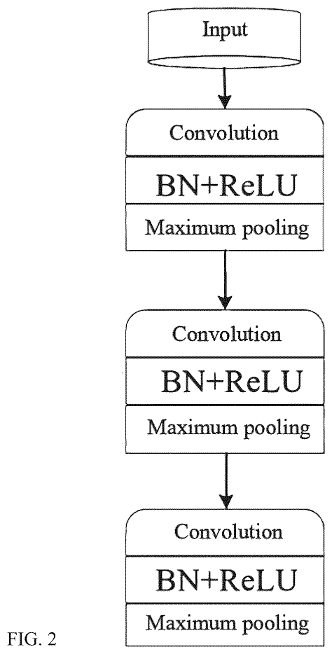

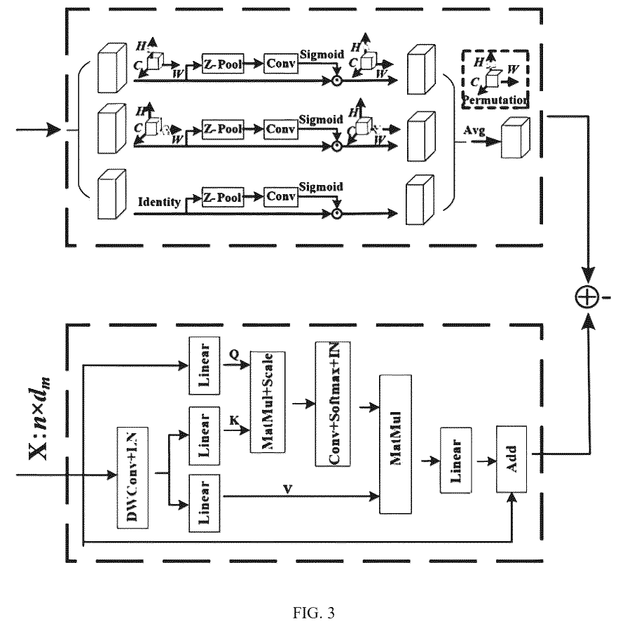

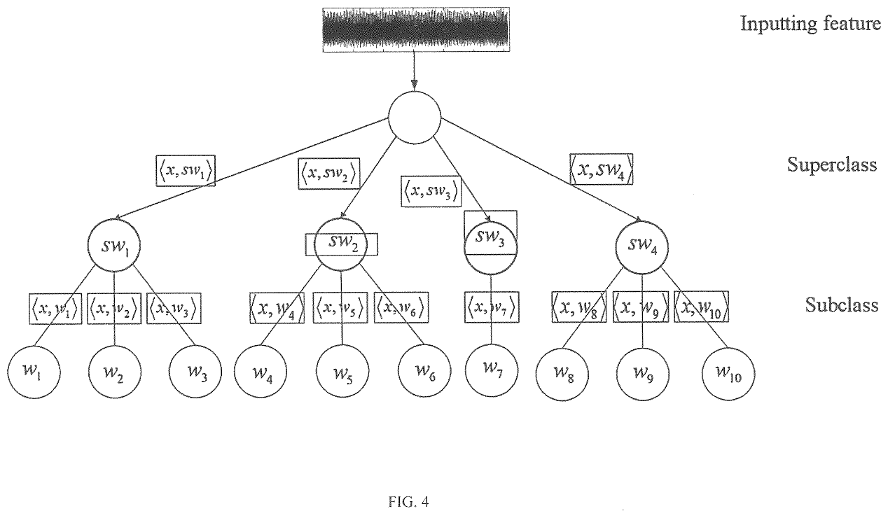

In order to realize the fault diagnosis of bearing health classification in unbalanced and strong noise environment, this embodiment proposes a hierarchical multi-class fault diagnosis model of dual attention guided tree-inspired grade decision network (DATGDN), as shown in FIG. 2, FIG. 3 and FIG. 4. The bearing vibration signals are diagnosed by using hierarchical multi-class fault diagnosis model, and the fault position and size are determined, which not only reduces the complexity of diagnosis tasks, but also enhances the accuracy of fault diagnosis.

The hierarchical multi-class fault diagnosis model includes dual attention-guided mechanism and tree-inspired grade decision network, and the construction method is as follows: firstly, the ternary attention mechanism and multi-head convolutional attention mechanism are integrated into a new convolutional neural network (CNN) model to form a dual attention-guided mechanism (as shown in FIG. 3) to enhance the information closely related to fault information in bearing fault signals and weaken the interference information that is not closely related to fault information; secondly, a hierarchical decision network with two-layer tree structure is designed to form a tree-inspired grade decision layer (as shown in FIG. 4), which is used to decide the position and size of bearing faults grade by grade. Finally, the tree-inspired grade decision layer is arranged behind the CNN model with dual attention guidance, and the hierarchical multi-class fault diagnosis model is seamlessly integrated.

In order to describe the proposed ternary attention mechanism more clearly, this embodiment first introduces cross-dimensional interaction and Z-pooling operation.

### (1) Cross-Dimensional Interaction

Cross-dimensional interaction involves solving the problem of insufficient interdependence between channels and spatial dimensions in traditional methods. Usually, traditional methods use singular weights when calculating channel attention, which leads to obvious loss of spatial features in signal processing. This makes the channel dimension and the spatial dimension lack close correlation. In order to overcome this problem, convolutional block attention module (CBAM) is introduced, which takes spatial attention as a supplementary module of channel attention. Specifically, by introducing spatial attention, CBAM makes up for the shortage of where to pay attention in the channel, so that the model may understand the position that should be paid attention to in the channel more comprehensively. At the same time, channel attention still plays the role of specifying which channel to pay attention to, thus maintaining the attention to channel information.

### (2) Z-Pool

The task of Z-pool is to reduce the zero dimension of tensor to two by connecting the characteristics of global average pooling (GAP) and global max pooling (GMP) in dimensions. The objective of this operation is to improve the efficiency of subsequent calculation by reducing the depth while maintaining the comprehensive representation of the original tensor. The introduction of Z-pool layer enables the model to process the input data more effectively, while still maintaining a comprehensive grasp of the overall characteristics. The mathematical expression is shown in Formula (1). Z-Pool operation generates a tensor with the shape of (C×H×W) into a tensor with the shape of (2×H×W).

$$Z - pool ( 𝒳 ) = [ G M {P}_{0 d} ( 𝒳 ) , G A {P}_{0 d} ( 𝒳 ) ] , \qquad ( 1 )$$

where 0d represents the 0-th latitude of the tensor to which GMP and GAP operations are performed; x represents the input tensor.

As shown in FIG. 3, for a given input tensor x∈R^{C×H×W}, ternary attention is transferred to three branches of the proposed ternary attention module.

In the first branch, the interaction between the height dimension and the channel dimension is constructed. In order to realize this function, firstly, the input tensor x is rotated 90° counterclockwise along the H axis to generate a rotation tensor x_{0H} with the shape of (W×H×C); secondly, x_{0H} is further processed by Z-Pool operation to obtain x_{0HZ} with the shape and size of (2×H×C); thirdly, x_{0HZ} is convolved with a convolution kernel with a kernel size of k×k, and batch normalization is performed to generate an intermediate output tensor with a dimension of (1×H×C); next, the generated intermediate output tensor is processed by sigmoid activation layer (σ) to generate attention weight and applied to x_{0H}; finally, rotating 90° clockwise along the H axis to generate the attention weight tensor which is consistent with the shape of the original input tensor x.

Similarly, in the second branch, the original signal rotates 90° counterclockwise along the W axis to generate a rotation tensor x_{1w} with a shape and size of (H×C×W); secondly, Z-pool operation is performed on the tensor to obtain x_{1WZ} with the shape and size of (2×C×W); thirdly, x_{1WZ} is convolved with a convolution kernel with a kernel size of k×k, and batch normalization is performed to generate an intermediate output tensor with a dimension of (1×H×C); next, the generated intermediate output tensor is processed by sigmoid activation layer (σ) to generate attention weight and applied to x_{1W}; finally, rotating 90° clockwise along the W axis to generate the attention weight tensor which is consistent with the shape of the original input tensor x.

For the third branch, firstly, x whose input tensor shape is (C×H×W) is directly transformed into a tensor x_{2Z} whose shape and size are (2×H×W) through Z-pool operation; secondly, x_{2Z} is convolved with a convolution kernel with a kernel size of k×k, and batch normalization is performed to generate an intermediate output tensor with a dimension of (1×H×C); finally, the intermediate output tensor is processed by sigmoid activation layer (σ) to generate an attention weight tensor with a shape and size of (1×H×W).

Finally, the tensor with the shape and size of (C×H×W) generated by the three branches are combined first and then averaged to get the refined attention tensor y. The calculation process is shown in Formula (2):

$$y = \frac{1}{3} \overline{( {x}_{0 H} σ ( {ψ}_{1} ( {x}_{0 HZ} ) )} + \overline{{x}_{1 W} σ ( {ψ}_{2} ( {x}_{1 WZ} ) )} + x σ ( {ψ}_{3} ( {x}_{2 z} ) ) ) , \qquad ( 2 )$$

where ψ₁, ψ₂ and ψ₃ all represent standard convolution operations.

Formula (2) may be simplified to Formula (3):

$$y = \frac{1}{3} ( \overline{{x}_{0 H} {ω}_{1}} + \overline{{x}_{1 W} {ω}_{2}} + x {ω}_{3} ) = \frac{1}{3} ( \overline{{y}_{1}} + \overline{{y}_{2}} + {y}_{3} ) . \qquad ( 3 )$$

In the formula, ω₁, ω₂ and ω₃ respectively represent the three cross-dimensional attention weights calculated in the three branches of ternary attention; y₁, y₂ and y₃ respectively represent the attention weight tensors generated by the first branch, the second branch and the third branch.

In short, the ternary attention mechanism introduces CBAM through the concept of cross-dimensional interaction, which makes the interaction between channel and space dimensions more compact and comprehensive. Further, ternary attention may consider the information of channel, space and channel-space cross dimensions at the same time, and improve the model's perception ability of key features.

As shown in FIG. 3, this embodiment also proposes multi-head convolutional self-attention (MCSA) based on single convolutional attention (SCA). MCSA aims to reduce the cost of memory use and calculation in the process of training or inference, while maintaining the interactivity and diversity between bulls. MCSA overcomes the limitation of memory and calculation of standard MSA, so as to deal with the processing requirements of large-scale data and high-dimensional data more effectively, which enables MCSA to handle complex tasks while maintaining the advantages of multi-head self-attention mechanism. The specific methods are as follows:
firstly, the one-dimensional original signals are embedded to generate a two-dimensional input tensor x₁∈R^{n×d}^{ₘ}, where n and dₘ represent the spatial dimension and channel dimension of x₁, respectively;
secondly, like MSA, MCSA first uses a set of projections to obtain a query. At the same time, in order to effectively compress the memory, the two-dimensional input tensor x₁∈R^{n×d}^{ₘ} is reshaped into a three-dimensional tensor x₁∈R^{d}^{ₘ}^{×h×w} along the spatial dimension;
thirdly, the three-dimensional input tensor x₁∈R^{d}^{ₘ}^{×h×w} is subjected to depth separable convolution (DWConv) and layer normalization technology to obtain a new three-dimensional tensor x₂∈R^{d}^{ₘ}^{×h×w}; in the depth separable convolution operation, the three-dimensional input tensor x₂∈R^{d}^{ₘ}^{×h×w} reduces its height and width dimensions by a scaling factor s (depending on the size of the feature map) to obtain a new tensor \hat{x}∈R^{d}^{ₘ}^{×h×w}, where the convolution kernel size, step size and padding are s+1, s and s/2, respectively.

Next, the new three-dimensional input tensor \hat{x}∈R^{d}^{ₘ}^{×h×w} is reshaped into a new two-dimensional input tensor \hat{x}∈R^{n×d}^{ₘ}, and two sets of fully connected feature maps are respectively performed to obtain the Key and Value, where n=(h/s)×(w/s).

Furthermore, Formula (5) is used to calculate the Query (Q), Key (K) and Value (V) in the attention function instead of Formula (4), and the Query and Key are multiplied and normalized, and then input into the convolution operation with Softmax and perform the instance normalization (IN) operation.

$$CSA ( Q , K , V ) = IN ( Softmax ( Conv ( \frac{{QK}^{T}}{\sqrt{{d}_{k}}} ) ) ) V \qquad ( 4 )$$

$$SA ( Q , K , V ) = Softmax ( Conv ( \frac{{QK}^{T}}{\sqrt{{d}_{k}}} ) ) V \qquad ( 5 )$$

where Conv(·) stands for standard 1*1 convolution operation, which is used to construct the interaction of information between different heads in multi-head attention; dₖ represents the channel latitude of the input data; CSA stands for convolution self-attention mechanism; SA stands for self-attention mechanism; T stands for transposition.

Finally, the output values of each head are connected in series and linearly projected to form the final output.

$$MCSA ( Q , K , V ) = Concat ( {head}_{i} ) {W}^{O} \qquad ( 6 )$$

where W^{O} represents the weight matrix generated by linear projection operation; MCSA stands for multi-head convolutional self-attention mechanism; Concat stands for connection operation; headᵢ stands for detection head.

After the multi-head convolutional attention mechanism is completed, the multi-head convolutional attention mechanism is integrated with the ternary attention mechanism into the CNN model to form a dual attention-guided convolutional neural network (DACNN), which is regarded as the backbone network of the overall multi-class fault diagnosis model. In the constructed DACNN, two kinds of attention are used as two branches to enhance CNN respectively, which ensures that the bearing fault features extracted by the two attention mechanisms to enhance CNN network will not interfere with each other. Finally, two kinds of fault features extracted by CNN with enhanced attention are aggregated. This operation ensures that each fault feature extracted by CNN with individual attention enhancement retains the specific meaning, and ensures that these features reinforce each other rather than weaken each other.

There is an inherent logical relationship between fault location and fault size severity, which is not reflected in most deep learning models. In this embodiment, a novel tree-inspired grade decision network is designed, as shown in FIG. 4, and the diagnostic logic between fault location and fault size is constructed. The tree-inspired grade decision network is designed based on the basic logic of fault diagnosis task. In this embodiment, a two-layer hierarchical fault diagnosis architecture is deployed, which corresponds to the fault type layer and the fault size layer of the bearing respectively. The first layer focuses on determining the fault type of input samples to obtain the corresponding superclass attributes, while the second layer focuses on determining the fault size of input samples to obtain the corresponding subclass attributes.

In order to understand the distribution of embedded features generated by this model more clearly, a tree-inspired grade decision network with two-layer structure is built by using two fully connected layers. In this process, the weight information generated by the fully connected layers in the backbone network is inherited by the thresholds of the seed nodes of the tree-inspired grade decision network, and the threshold of the leaf node is further determined by the embedding decision rules of the seed nodes and the leaf nodes. The weight of seed nodes directly inherits the probability distribution of the pre-trained fully connected layer, which ensures that the recognition ability of subclasses is similar to that of the pre-trained hierarchical multi-class fault diagnosis model.

The bearing vibration signals in known state are input into the multi-class fault diagnosis model for training, and the hierarchical multi-class fault diagnosis model is constructed.

S3, determining the fault position and size of the bearing by using a hierarchical multi-class fault diagnosis model.

The unknown bearing vibration signals are input into the trained multi-class fault diagnosis model, and the health state of the bearing is measured.

### Embodiment 2

This embodiment also provides a system of bearing fault diagnosis based on a dual attention mechanism to strengthen a hierarchical decision network, including an acquisition module, a construction module and a detection module; the acquisition module is used for acquiring bearing vibration signals in different health states; the construction module is used to build a hierarchical multi-class fault diagnosis model based on bearing vibration signals; and the detection module is used to determine the fault position and size of the bearing by using the hierarchical multi-class fault diagnosis model.

Hierarchical multi-class fault diagnosis model includes dual attention-guided mechanism and tree-inspired grade decision network; the dual attention-guided mechanism is used to enhance the information closely related to the fault information in the bearing fault signals and weaken the interference information that is not related to the fault information. tree-inspired grade decision network is used to decide the position and size of bearing fault grade by grade. The workflow of the construction module includes: ternary attention mechanism and multi-head convolutional attention mechanism are integrated into a CNN model to form a dual attention-guided mechanism; among them, the ternary attention mechanism introduces the convolutional block attention module through the concept of cross-dimensional interaction, which makes the interaction between the channel and the spatial dimension more compact and comprehensive; multi-head convolutional self-attention mechanism is constructed based on the single-head convolutional attention.

In this embodiment, a heuristic hierarchical decision network based on the basic logic design tree of fault diagnosis tasks includes a fault type layer and a fault size layer; the fault type layer is used to determine the fault type of the input sample; the fault size layer is used to determine the fault size of the input sample. The dual attention-guided mechanism is used as the backbone network of hierarchical multi-class fault diagnosis model; meanwhile, a tree-inspired grade decision network with two-layer structure is built by using two fully connected layers. The weight information generated by the fully connected layers in the backbone network is inherited by the thresholds of the seed nodes of the tree-inspired grade decision network, and the thresholds of the leaf nodes are further determined by the embedding decision rules of the seed nodes and the leaf nodes.

The above-mentioned embodiment is only a description of the optional mode of the disclosure, and does not limit the scope of the disclosure. Under the premise of not departing from the design spirit of the disclosure, various modifications and improvements made by ordinary technicians in the field to the technical scheme of the disclosure shall fall within the protection scope determined by the claims of the disclosure.

What is claimed is:

1. A method of bearing fault diagnosis based on dual attention mechanism to strengthen hierarchical decision network, comprising following steps:
collecting bearing vibration signals in different health states;
based on the bearing vibration signals, constructing a hierarchical multi-class fault diagnosis model; wherein the hierarchical multi-class fault diagnosis model comprises dual attention-guided mechanism and tree-inspired grade decision network; wherein a construction method of the dual attention-guided mechanism comprises: integrating ternary attention mechanism and multi-head convolutional attention mechanism into a new convolutional neural network (CNN) model to form the dual attention-guided mechanism; wherein multi-head convolution self-attention is constructed based on single-head convolution attention, and steps comprise:
firstly, generating a two-dimensional input tensor x₁∈R^{n×d}^{ₘ} from a one-dimensional original signal by an embedded coding method, wherein n and dₘ represent a spatial dimension and a channel dimension of x₁, respectively;
secondly, using a set of projections to obtain a query, and at the same time, reshaping the two-dimensional input tensor x₁∈R^{n×d}^{ₘ} into a three-dimensional tensor x₁∈R^{d}^{ₘ}^{×h×w} along the spatial dimension;
thirdly, subjecting the three-dimensional input tensor x₁∈R^{d}^{ₘ}^{×h×w} to depth separable convolution and layer normalization technology to obtain a new three-dimensional tensor x₂∈R^{d}^{ₘ}^{×h×w}; and in the depth separable convolution operation, reducing a height dimension and a width dimension of the three-dimensional input tensor x₂∈R^{d}^{ₘ}^{×h×w} by a scaling factor s to obtain a new tensor \hat{x}∈R^{d}^{ₘ}^{×h×w}, wherein a convolution kernel size, a step size and a padding are s+1, s and s/2, respectively;
next, reshaping the new three-dimensional input tensor \hat{x}∈R^{d}^{ₘ}^{×h×w} into a new two-dimensional input tensor \hat{x}∈R^{n×d}^{ₘ}, and respectively performing two sets of fully connected feature maps to obtain Key and Value, wherein n=(h/s)×(w/s);
furthermore, calculating Query, Key and Value in an attention function, multiplying and normalizing the Query and the Key, and inputting the result into a convolution operation with Softmax and performing an instance normalization operation, wherein a calculation formula is as follows:
$$SA ( Q , K , V ) = Softmax ( Conv ( \frac{{QK}^{T}}{\sqrt{{d}_{k}}} ) ) V ,$$
wherein Q stands for the Query; K stands for the Key; V stands for the Value; Conv(·) stands for a standard 1*1 convolution operation, used to construct an interaction of information between different heads in multi-head attention; dₖ represents a channel latitude of input data; SA stands for self-attention mechanism; and T stands for transposition; and
finally, connecting output values of each head in series and applying a linear projection to form a final output;
$$MCSA ( Q , K , V ) = Concat ( {head}_{i} ) {W}^{O} ,$$
wherein W^{O} represents a weight matrix generated by the linear projection operation; MCSA stands for multi-head convolutional self-attention mechanism; Concat stands for the connection operation; and headᵢ stands for detection head; and
determining a fault position and a size of a bearing by using the hierarchical multi-class fault diagnosis model.

2. The method of the bearing fault diagnosis based on the dual attention mechanism to strengthen the hierarchical decision network according to claim 1, wherein the dual attention-guided mechanism is used to enhance information closely related to fault information in bearing fault signals and weaken interference information not closely related to the fault information; and
the tree-inspired grade decision network is used to decide a position and a size of bearing faults grade by grade.

3. The method of the bearing fault diagnosis based on the dual attention mechanism to strengthen the hierarchical decision network according to claim 2, wherein the ternary attention mechanism introduces a convolutional block attention module through a concept of cross-dimensional interaction, making an interaction between a channel dimension and a spatial dimension more compact and comprehensive; and
the multi-head convolutional self-attention mechanism is used to reduce cost of memory use and calculation in a process of training or inference, while maintaining interactivity and diversity among multi-heads.

4. The method of the bearing fault diagnosis based on the dual attention mechanism to strengthen the hierarchical decision network according to claim 2, wherein the tree-inspired grade decision network is designed based on basic logic of fault diagnosis tasks, comprising: a fault type layer and a fault size layer; wherein
the fault type layer is used for determining a fault type of an input sample; and
the fault size layer is used for determining a fault size of the input sample.

5. The method of the bearing fault diagnosis based on the dual attention mechanism to strengthen the hierarchical decision network according to claim 2, wherein the dual attention-guided mechanism is used as a backbone network of the hierarchical multi-class fault diagnosis model; meanwhile, the tree-inspired grade decision network with a two-layer structure is built by using two fully connected layers; weight information generated by the fully connected layers in the backbone network is inherited by thresholds of seed nodes of the tree-inspired grade decision network, and thresholds of leaf nodes are further determined by embedding decision rules of the seed nodes and the leaf nodes.

6. A system of bearing fault diagnosis based on dual attention mechanism to strengthen hierarchical decision network, wherein the system is used to realize the method of claim 1, comprising: an acquisition module, a construction module and a detection module;
wherein the acquisition module is used for acquiring the bearing vibration signals in the different health states;
the construction module is used for building the hierarchical multi-class fault diagnosis model based on the bearing vibration signals; and
the detection module is used for determining the fault position and the size of the bearing by using the hierarchical multi-class fault diagnosis model.

7. The system of the bearing fault diagnosis based on the dual attention mechanism to strengthen the hierarchical decision network according to claim 6, wherein the hierarchical multi-class fault diagnosis model comprises the dual attention-guided mechanism and the tree-inspired grade decision network;
the dual attention-guided mechanism is used to enhance information closely related to fault information in bearing fault signals and weaken interference information not closely related to the fault information; and
the tree-inspired grade decision network is used to decide a position and a size of bearing faults grade by grade.

8. The system of the bearing fault diagnosis based on the dual attention mechanism to strengthen the hierarchical decision network according to claim 7, wherein a workflow of the construction module comprises: integrating the ternary attention mechanism and the multi-head convolutional attention mechanism into the CNN model to form the dual attention-guided mechanism;
wherein the ternary attention mechanism introduces a convolutional block attention module through a concept of cross-dimensional interaction, making an interaction between a channel dimension and a spatial dimension more compact and comprehensive; and
the multi-head convolutional self-attention mechanism is used to reduce cost of memory use and calculation in a process of training or inference, while maintaining interactivity and diversity among multi-heads.
